(19) United States
(12) Patent Application Publication
(10) Pub. No.: US 2016/0329138 A1
(43) Pub. Date: Nov. 10, 2016

(54) OXIDE SUPERCONDUCTING BULK MAGNET

(71) Applicant: NIPPON STEEL & SUMITOMO METAL CORPORATION, Tokyo (JP)

(72) Inventor: Mitsuru MORITA, Tokyo (JP)

(73) Assignee: NIPPON STEEL & SUMITOMO METAL CORPORATION, Tokyo (JP)

(21) Appl. No.: 15/111,899

(22) PCT Filed: Mar. 4, 2015
(86) PCT No.: PCT/JP2015/056402

§ 371 Date: Jul. 15, 2016

(30) Foreign Application Priority Data
Mar. 4, 2014 (JP) 2014-041591

(51) Int. Cl. H01F 1/10; H01F 6/00; H01F 1/053

(52) U.S. Cl. CPC H01F 1/10; H01F 1/053; H01F 6/00

(57) ABSTRACT

The present invention provides an oxide superconducting bulk magnet able to generate a strong magnetic field without fracturing at the time of magnetization in a 5 T or more high magnetic field even if a diameter 50 mm or more large size. The oxide superconducting bulk magnet is an oxide superconducting bulk magnet comprised of a REBa₂Cu₃O₇₋ₓ phase in which RE₂BaCuO₅ phases are dispersed, structured having a center core part with a reinforcing material provided at its outer periphery part and having, centered at the center core part, one or more ring-shaped oxide superconducting bulk magnets with reinforcing materials provided at their outer periphery parts and arranged in a nested manner, where,
RE: a rare earth element or combination of the same;
x: amount of oxygen deficiency, 0<x≦0.2

### TECHNICAL FIELD

The present invention relates to an oxide superconducting bulk magnet.

### BACKGROUND ART

An oxide superconducting material comprised of an REBa₂Cu₃O₇₋ₓ (RE: rare earth element) phase in which RE₂BaCuO₅ phases are dispersed to form a superconducting bulk material has a high critical current density (Jc), so is magnetized by cooling in a magnetic field or by pulsed field magnetization and can be used as an oxide superconducting bulk magnet. For example, PLT 1 discloses an apparatus for generating a superconducting magnetic field which makes the oxide superconductor materials (oxide superconducting bulk magnets) become usable in superconducting motors etc.

Further, NPLT 1 discloses a superconducting bulk magnet which can generate a maximum 1.5 T or so magnetic field using a diameter 36 mm columnar Sm-based superconducting bulk magnet magnetized by cooling in a magnetic field. Further, NPLT 2 discloses a comparative investigation of the magnetization caused by cooling in a magnetic field and the pulsed field magnetization using a Y-based bulk superconducting material. Furthermore, NPLT 3 shows that an about 4.5 T magnetic field at 40K is generated using a diameter about 60 mm bulk superconducting material in a superconducting magnet. As the pulsed field magnetization of an RE-based bulk superconducting material, PLT 1 discloses pulsed field magnetization accompanied with flux jumps. Further, NPLT 2, NPLT 3, etc. disclose magnetization methods including cooling methods.

Recently, PLT 4 has disclosed a superconducting bulk magnet comprised of a ring-shaped bulk superconductor (RE^{II}Ba₂Cu₃O₇₋ₓ) having a high critical current density (Jc) characteristic at a low magnetic field and having the inner side at which two types of RE-based superconducting bulk magnets of columnar shaped bulk superconductors (RE^{I}Ba₂Cu₃O₇₋ₓ) having high Jc characteristics at a high magnetic field are arranged so as to thereby obtain a large trapped magnetic field from a low magnetic field to a high magnetic field. Note that, the superconducting bulk magnet is magnetized in a static magnetic field.

Further, PLT 5 discloses a superconducting bulk magnet arranging two types or three types of RE-based superconducting bulk magnets with different compositions (that is, different superconducting characteristics) so as to obtain a large trapped magnetic field from a low magnetic field to a high magnetic field (in particular, see FIG. 1, FIG. 5, and FIG. 8 of PLT 5). Specifically, the superconducting bulk magnet comprises two types (or three types) of superconducting bulk magnets with different critical current density characteristics. In the superconducting bulk magnet, a material having a large critical current density at a low magnetic field is arranged at the peripheral part, and a material having a high current density in a high magnetic field is arranged at the center part where the magnetic field strength becomes higher so as to enable a strong magnetic field to be generated as a whole. As the magnetization method, the case of using a static magnetic field magnetization method to obtain a superconducting magnet and the case of using a pulsed field magnetization method to obtain a superconducting magnet are described.

The oxide superconductor materials described in PLT 6 basically is an oxide superconducting bulk magnet with a hollow inside, which is formed by combining a plurality of hollow oxide superconducting bulk magnets so as to economize on the starting materials and fabricate a light weight oxide superconducting bulk. By making the magnet hollow in this way, it is considered possible to lighten the weight. Further, for magnetization of the superconducting bulk magnet, the method of dipping it in liquid nitrogen to render it a superconducting state and applying a magnetic field from the outside to trap magnetic flux lines in the superconductor and obtain a permanent magnet, that is, the static magnetic field magnetization method, is used. Further, PLT 7 discloses solving the problem of the drop in characteristics due to the generation of heat at the pulsed field magnetization by providing a channel for a coolant between the superconductors to improve the trapped magnetic flux characteristic at the time of the pulsed field magnetization. Furthermore, PLT 8 discloses controlling the path of current at the time of pulsed field magnetization by a superconducting bulk magnet comprised of ring-shaped superconducting bulk magnets arranged in a nested manner and enabling uniform magnetization close to a concentric shape. Further, PLT 9 discloses, for a similar object, stacking superconducting sheets of multiple ring-shaped superconducting bulks having joints at one or more locations so as to limit the current paths and using pulsed field magnetization to obtain a uniform trapped magnetic field distribution.

As explained above, in an RE-based (RE-Ba—Cu—O-based) oxide superconducting bulk magnet, the magnetic field strength of the magnet is improved by the configuration and magnetization method of the oxide superconducting bulk magnets forming the superconducting bulk magnet and the prevention of fracturing due to the hoop force by reinforcement of the outer periphery ring.

### CITATIONS LIST

### Patent Literature

PLT 1. Japanese Patent Publication No. 6-20837A
PLT 2. Japanese Patent Publication No. 6-168823A
PLT 3. Japanese Patent Publication No. 10-12429A
PLT 4. Japanese Patent Publication No. 2001-358007A
PLT 5. Japanese Patent Publication No. 9-255333A
PLT 6. Japanese Patent Publication No. 7-211538A
PLT 7. Japanese Patent Publication No. 2006-319000A
PLT 8. Japanese Patent Publication No. 2011-142303A
PLT 9. Japanese Patent Publication No. 2011-199298A
PLT 10. Japanese Patent Publication No. 11-284238A
PLT 11. Japanese Patent Publication No. 11-335120A
PLT 12. Japanese Patent Publication No. 2000-178025A
PLT 13. Japanese Patent Publication No. 2001-10879A
PLT 14. Japanese Patent Publication No. 7-182934A

### Nonpatent Literature

NPLT 1. Ikuta et al.; Journal of the Magnetics Society of Japan, Vol. 23, No. 4-1 (1999), p. 885
NPLT 2. Y. Itoh et al., Jpn J. Appl. Phys., Vol. 34, 5574 (1995)
NPLT 3. Morita et al.; Journal of the Magnetics Society of Japan, Vol. 19, No. 3 (1995), p. 744
NPLT 4. Nariki et al.; Teion Kogaku, Vol. 40, No. 7, 2005

### SUMMARY OF INVENTION

### Technical Problem

An oxide superconducting bulk magnet comprised of an REBa₂Cu₃O₇₋ₓ phase (123 phase) in which RE₂BaCuO₅ phases (211 phases) are dispersed functions as a source of generation of a magnetic field (superconducting bulk magnet) like a permanent magnet in a superconducting state upon magnetization. The generated magnetic field strength is roughly proportional to the size of the superconducting bulk magnet and the critical current density of the bulk superconducting material. For example, in the case of a columnar shaped superconducting bulk magnet such as shown in FIGS. 3A and 3B, by magnetization with a sufficiently high magnetic field strength in static magnetic field, the magnetic field strength at the center of the columnar surface is proportional to the diameter (D) and the critical current density (Jc). The critical current density Jc changes due to the cooling temperature of the superconducting bulk magnet and has a critical current density Jc higher the lower the temperature. Specifically, it has been reported that by reinforcing silver-containing Gd-based bulk superconducting material having a diameter 45 mm and thickness 15 mm at its outer periphery part with a stainless steel ring the bulk superconducting material generates a 1.8 T magnetic field at 77K, 3.8 T at 70K, and 7.0 T at 60K (Tejima et al.: Teion Kogaku). By magnetization at a low temperature in this way, it is possible to trap a higher strength magnetic field and obtain a superconducting bulk magnet generating a high magnetic field.

In the past, by fitting a metal ring over the outer periphery part of this columnar superconducting bulk magnet or ring-shaped superconducting bulk magnet in a room temperature state, cooling to the magnetization temperature, and utilizing the difference in the coefficients of heat expansion, the hoop force generated by the magnetic field trapped at the superconducting bulk magnet was suppressed and fracturing of the superconducting bulk magnet was prevented. By this method, a diameter 30 mm or more relatively large sized superconducting bulk magnet generating a 6 to 9 T or so has been reported. However, even at this level of magnetic field strength, there are reports of fracturing of the superconducting bulk magnet (H. Ikuta et al., Advances in Superconductivity, XII, p. 658, and T. Yamada; Physica C392-396 (2003), 623-627). In particular, the reinforcement technology for prevention of fracturing required for generating a high strength magnetic field in the low temperature region (in particular 20 to 50K) of an over diameter 50 mm relatively large sized member has been incomplete.

In the conventional art of reinforcing the outer periphery part by a metal ring, PLT 10 discloses a method of arranging a metal ring at the outer periphery part of a columnar shaped superconducting bulk magnet and arranging a resin between the superconducting bulk magnet and the ring. Further, PLT 11 discloses a method of processing the outer periphery diameter of a superconducting bulk magnet and the inner periphery diameter of a metal reinforcement ring at a high dimensional precision and shrink-fitting them or burying the slight gap between the ring and superconducting bulk magnet by a resin.

Furthermore, PLTs 12 and 13 disclose the method of impregnating microcracks in a superconducting bulk magnet with a resin, then placing a reinforcing resin at the periphery of the superconducting bulk magnet including the outer periphery part. Further, PLT 14 discloses the method of arranging a rectangular shaped high strength material for supporting the outer periphery at the outer periphery part of the ring-shaped superconducting bulk magnet. In particular, FIG. 2 of PLT 14 discloses a superconducting bulk magnet comprised of a ring-shaped superconducting bulk magnet having the inner side at which a high strength material for supporting the inner periphery is entirely arranged.

These reinforcement methods are insufficient for generating an over 5 T high strength magnetic field when in particular a diameter 50 mm or more relatively large superconducting bulk magnet is fully magnetized in the less than 50K relatively low temperature region (state where entire superconducting bulk magnet is magnetized in a substantially critical state). A stable reinforcement method cannot be obtained with good reproducibility. This is because the strength of a superconducting bulk magnet is originally a low one of about 70 MPa.

PLT 10 shows a method of reinforcing various shapes of superconducting bulk magnets by support parts and support members arranged around the superconducting bulk magnets. However, PLT 10 does not disclose anything regarding a ring superconducting bulk magnet with an outer periphery part reinforced by a high strength metal ring and a superconducting bulk magnet arranged and reinforced in a nested manner at the center core part.

PLT 11 discloses a method of reinforcing the periphery of a columnar or cylindrical superconducting bulk magnet by a high strength metal ring. However, PLT 11 does not disclose anything regarding a ring superconducting bulk magnet with an outer periphery part reinforced by a high strength metal ring and a superconducting bulk magnet arranged and reinforced in a nested manner at the center core part.

PLTs 12 and 13 disclose an oxide superconductor which is reinforced not by reinforcement by a metal ring but by a resin impregnated layer and closely covering layer of cloth impregnated with a resin and which is strong against deterioration due to corrosion. However, PLTs 12 and 13 do not disclose anything regarding a ring superconducting bulk magnet with an outer periphery part reinforced by a high strength metal ring and a superconducting bulk magnet arranged and reinforced in a nested manner at the center core part.

PLT 14 discloses a superconducting bulk magnet comprised of a superconducting bulk magnet having through-holes and covered around periphery thereof with a high strength material. However, PLT 14 does not disclose anything regarding a ring superconducting bulk magnet with an outer periphery part reinforced by a high strength metal ring and a superconducting bulk magnet arranged and reinforced in a nested manner at the center core part.

PLT 8 describes the nested ring superconducting bulk magnets and the center core part and discloses insertion of solder in the gap between them to obtain a joined superconducting bulk magnet. However, PLT 8 does not disclose anything regarding a ring superconducting bulk magnet with an outer periphery part reinforced by a high strength metal ring and a superconducting bulk magnet arranged and reinforced in a nested manner at the center core part.

PLT 9 discloses a superconducting bulk magnet comprised of concentric rings which have joints close to ring shapes and which are joined by using solder to bury the gaps, but since the superconducting bulk magnets have joints, reinforcing them by a metal ring is difficult. PLT 9 does not disclose anything regarding a ring superconducting bulk magnet with an outer periphery part reinforced by a high strength metal ring and a superconducting bulk magnet arranged and reinforced in a nested manner at the center core part.

FIG. 1B of NPLT 4 describes a bulk magnet comprised of a diameter 48 mm, inside diameter 24 mm, height 21 mm ring-shaped bulk sample having the inner side at which an outside diameter 24 mm, thickness 1.0 mm aluminum ring and diameter 22 mm columnar bulk sample are inserted and an epoxy resin is filled at the entire periphery of the gaps between them. Further, the sample is shown as more easily fracturing compared with a sample only given a conventional outer peripheral ring (see FIG. 1A). However, a bulk magnet comprised of a ring-shaped bulk with an outer periphery part reinforced or ring-shaped bulk with an outer periphery part and inner periphery part reinforced arranged in a nested manner with only part of the gaps filled with a resin, grease, or solder is not described at all.

The reinforcement methods described in these PLTs 8 to 14 in this way are insufficient for generation of an over 5 T high strength magnetic field when, in particular, an above-mentioned diameter 50 mm or more relatively large size superconducting bulk magnet is fully magnetized in a less than 50K relatively low temperature region (state where substantially the entire superconducting bulk magnet is magnetized in a substantially critical state) etc. A reinforcement method which is stable with good reproducibility cannot be obtained. This is because originally a superconducting bulk magnet has a strength of a low 70 MPa or so.

The present invention, in consideration of the above problem, has as its object the provision of an oxide superconducting bulk magnet comprised of an REBa₂Cu₃O₇₋ₓ phase in which RE₂BaCuO₅ phases are dispersed, wherein the oxide superconducting bulk magnet is able to generate a strong magnetic field without fracturing at the time of magnetization in a 5 T or more high magnetic field even if a diameter 50 mm or more large size.

### Solution to Problem

The inventors reinforce each of the outer periphery parts of one or more ring-shaped oxide superconducting bulk magnets by the ring-shaped reinforcing material, and arrange these in a nested manner for reinforcement.

On the other hand, a large stress is not generated in an axial direction of columnar and ring-shaped superconducting bulk magnets, so there is no need to place reinforcing materials in the axial direction. Rather if placing reinforcing materials stacked or with gaps, the effective magnetic field space is made narrower, so it is preferable that there be no reinforcing materials in the axial direction.

Further, by dividing a single columnar superconducting bulk magnet into a plurality of nested ring-shaped oxide superconducting bulk magnets and reinforcing each of the ring-shaped oxide superconducting bulk magnets and the oxide superconducting bulk magnet of the center core part by metal rings, a reinforcement method able to effectively reinforce the center part where the stress becomes maximum is provided.

As to the fracturing of a superconducting bulk magnet at the time of trapping a strong magnetic field when reinforcing just an outer periphery part by a metal ring, something like the cause for the fracturing has not been studied. Countermeasures for the fracturing have not been studied either. Further, as a countermeasure, in actuality, processing a single columnar superconducting bulk magnet into, for example, an outer periphery ring part and a center core part and reinforcing these with metal rings requires precision processing technologies and can incur labor and costs for processing. Sometimes the effective diameter of the superconducting material is made smaller by the thickness of the reinforcing rings other than at the outermost periphery part. Up to now, it appears that a reinforcement method such as the present invention has never been considered.

That is, the present invention provides the following:

(1) An oxide superconducting bulk magnet comprised of a REBa₂Cu₃O₇₋ₓ phase in which the RE₂BaCuO₅ phases are dispersed, the oxide superconducting bulk magnet comprising a ring-shaped oxide superconducting bulk magnet with a reinforcing material provided at outer periphery part thereof and wherein at the inside of the ring-shaped oxide superconducting bulk magnet, one or more ring-shaped oxide superconducting bulk magnets with reinforcing materials provided at outer periphery parts thereof are and arranged to be nested manner, where,
RE: a rare earth element or combination of the same;
x: amount of oxygen deficiency, 0<x≦0.2
(2) The oxide superconducting bulk magnet according to (1), wherein a center core part of a columnar shaped oxide superconducting bulk magnet provided with a reinforcing material at outer periphery part thereof is placed at the inside of the nested ring-shaped oxide superconducting bulk magnets.
(3) The oxide superconducting bulk magnet according to (1) or (2), wherein the oxide superconducting bulk magnet can be magnetized to generate 5 T or more magnetic flux and has an outside diameter of 50 mm or more.
(4) The oxide superconducting bulk magnet according to any one of (1) to (3), wherein the reinforcing materials reinforcing the outer periphery parts of the nested ring-shaped oxide superconducting bulk magnets differ in thickness depending on the position.
(5) The oxide superconducting bulk magnet according to (4), wherein the reinforcing materials are made to be thicker from the outside to the inside of the oxide superconducting bulk magnets.
(6) The oxide superconducting bulk magnet according to any one of (1) to (5), wherein the shape of the ring-shaped oxide superconducting bulk magnets is a shape having a polygonal shape or elliptical shape, or top surface and bottom surface of said ring-shaped oxide superconducting bulk magnets are race track shapes.

### Advantageous Effects of Invention

According to the present invention, it is possible to provide an oxide superconducting bulk magnet able to stably generate a high magnetic field by magnetization. Further, since there is resistance to fracturing and cracking, it is possible to provide an oxide superconducting bulk magnet able to be magnetized with good symmetry and uniformity. Furthermore, since superconductors are arranged in a nested manner, it is possible to more easily realize an oxide superconducting bulk magnet generating a high magnetic field even by the pulsed field magnetization method, so it is possible to utilize a high magnetic field which cannot be obtained by an ordinary permanent magnet. The industrial effect is tremendous.

### BRIEF DESCRIPTION OF DRAWINGS

FIG. 1 is a view showing a distribution of stress which reinforcing materials exert on superconducting materials in the case where each of a plurality of ring-shaped superconducting bulk magnets arranged concentrically is cooled in a state reinforced by the reinforcing material.

FIG. 2 is a view showing a distribution of stress which a reinforcing material exerts on a superconducting material in the case where only the outer periphery part of a columnar superconducting bulk magnet is cooled in a state reinforced by a ring-shaped reinforcing material.

FIG. 3A is a perspective view showing a state of a superconducting current J in a columnar superconducting bulk magnet, while FIG. 3B is a view showing a relationship between the shape of the bulk magnet of FIG. 3A and the trapped magnetic field distribution.

FIG. 4A is a perspective view showing a shape of a ring-shaped superconducting bulk magnet, while FIG. 4B is a view showing a relationship between the shape of the bulk magnet of FIG. 4A and the trapped magnetic field distribution.

FIG. 5A is a perspective view showing a structure of an invention example of a sample AB prepared in Example 1, while FIG. 5B is a view showing the structure of a comparative example of a sample C1.

FIG. 6A is a perspective view showing a structure of an invention example of a sample D1ED2 prepared in Example 2, while FIG. 6B is a perspective view showing the structure of a comparative example of a sample C2.

FIG. 7A is a plan view showing a structure of an invention example of a sample S-12 prepared in Example 3, while FIG. 7B is a plan view showing the structure of a comparative example of a sample C3.

FIG. 8A is a plan view showing a structure of a sample R-12 prepared in Example 3, while FIG. 8B is a plan view showing a structure of the sample C4.

### DESCRIPTION OF EMBODIMENTS

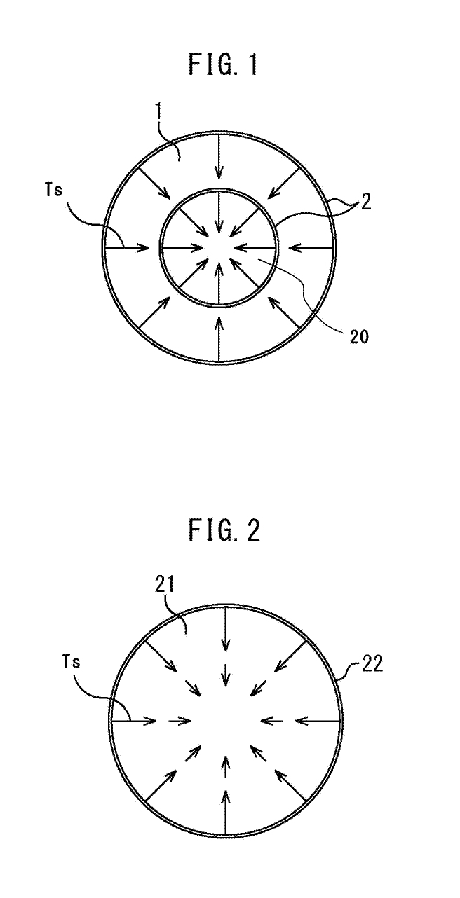

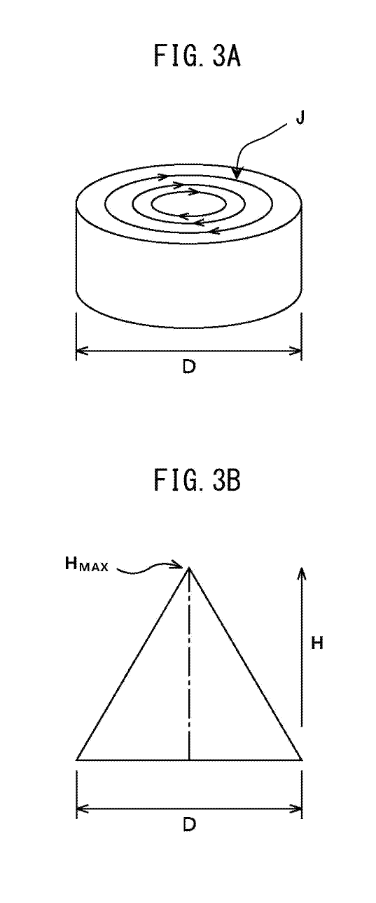

An effective reinforcement method for preventing fracturing is to reinforce the vicinity of the part at which the greatest stress acts. For example, when the overall outside shape is that of a columnar shaped superconducting bulk, like in FIG. 1, it is effective to not only reinforce the outermost periphery part by a reinforcing material 2, but also further reinforce the outer periphery part of an inside columnar superconducting bulk 20 arranged concentrically by a reinforcing material 2 to give a compressive stress Tₛ. When reinforcing only the outermost periphery part of a single columnar bulk, as shown in FIG. 2, compressive stress Tₛ due to the outer periphery reinforcing ring becomes smaller in the center part, and the reinforcing effect falls. Further, as shown in FIGS. 3A and 3B, when magnetizing a bulk by a sufficiently large magnetic field H so that a superconducting current J flows to a columnar shaped superconducting bulk, the magnetic field H becomes the maximum strength H_{MAX} at the center of the bulk, and the stress also becomes maximum. For this reason, in a columnar superconducting bulk, it is extremely effective to reinforce a part closer to the center part like in FIG. 1.

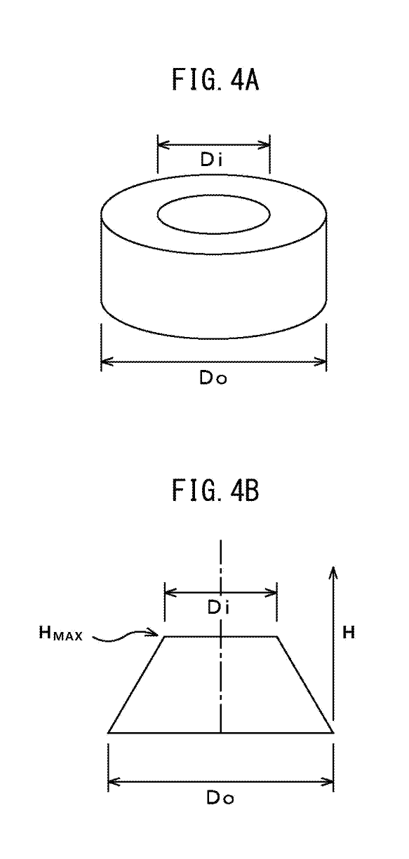

More specifically, when fully magnetizing a columnar superconducting bulk magnet, the distribution of the magnetic field strength H at the surface of the superconducting bulk magnet which has a columnar shape such as shown in FIG. 3A becomes a trigonal pyramidal shape having a peak at substantially the center of the surface such as shown in FIG. 3B. Further, when fully magnetizing a ring-shaped superconducting bulk magnet such as shown in FIG. 4A, the distribution of the magnetic field strength H at the surface of the superconducting bulk magnet, as shown in FIG. 4B, becomes like a solid of revolution of a shape obtained by rotating a trapezoid formed by cutting the part corresponding to the inner periphery from the trigonal pyramidal shape around the axis of the inner periphery part of the superconducting bulk magnet. The trapezoid has a flat part which corresponds to the inner periphery. Further, in the respective cases, the position where the maximum tensile stress acts is the center in the case of a column and is the inner periphery side surface in the case of a ring shape. Further, when fracturing occurs, the locations where the magnetic field H becomes the maximum strength H_{MAX} become locations where the stress becomes maximum, and these locations often become starting points of fracturing. For example, in the case of a columnar shape, the compressive stress becomes weaker at the center part in a state where compressive stress is applied from the outer periphery part by a metal ring, so fracturing starts at the center where the hoop force becomes maximum. On the other hand, in the case of the same compressive stress from the outer periphery metal ring, the larger the diameter of the column, the smaller the stress acting on the center part.

The inventors etc. studied in depth what kind of reinforcement structure should be employed for reinforcing with a high efficiency a relatively large size oxide superconducting bulk magnet using an outside diameter 50 mm or more RE-Ba—Cu—O-based oxide superconducting bulk magnet able to generate a 5 T or more magnetic flux by magnetization. As a result, while, in the past, for a one-piece bulk magnet, only the outer periphery part of an oxide superconducting bulk magnet was reinforced by a ring-shaped high strength metal, they came up with the conception of placing at the center part a center core member having the outer periphery part reinforced by a reinforcing material or a ring-shaped oxide superconducting bulk magnet, and arranging, in a nested manner, ring-shaped oxide superconducting bulk magnets comprised of one or more bulk magnets divided in a nested manner and reinforced at their outer periphery parts by high strength metal so as to form a superconducting bulk magnet and efficiently reinforce the center part which becomes the maximum point of stress.

The superconducting bulk forming the RE-Ba—Cu—O-based oxide superconducting bulk magnet used in the present invention has the structure comprised of a superconductor phase of a single crystal REBa₂Cu₃O₇₋ₓ phase (123 phase) in which non-superconducting phases of RE₂BaCuO₅ phases (211 phases) are finely dispersed. Here, the “single crystal shape” means not a perfect single crystal, but includes a crystal having low-angle grain boundaries and other defects not obstructing practical use. Further, a single crystal shape (quasi single crystal shape) is used because it is a crystal phase comprised of the single crystal 123 phase in which the 211 phases are finely dispersed (for example, to 1 μm or so). The RE in the REBa₂Cu₃O₇₋ₓ phase (123 phase) and RE₂BaCuO₅ phases (211 phases) indicates a rare earth element. It is a rare earth element comprised of Y, La, Nd, Sm, Eu, Gd, Dy, Ho, Er, Tm, Yb, and Lu or a combination of the same. Further, a 123 phase including La, Nd, Sm, Eu, and Gd may be off from the 1:2:3 stoichiochemical composition. Ba may be partially substituted at the sites of RE, but this is deemed to be included in the 123 phase of the present invention. Further, in the non-superconducting phases of the 211 phases as well, La and Nd are somewhat different from Y, Sm, Eu, Gd, Dy, Ho, Er, Tm, Yb, and Lu. It is known that the ratios of metal elements of La and Nd in the 211 phases are non-stoichiochemical compositions, or the 211 phases including La and Nd have a different crystal structure. However, in these cases as well, the 211 phases including La and Nd are included in the 211 phases of the present invention. Further, the “x” of the REBa₂Cu₃O₇₋ₓ phase is the amount of oxygen-deficiency where 0<x≦0.2. This is because if “x” is in the above-mentioned range, the REBa₂Cu₃O₇₋ₓ phase exhibits a superconducting property as a superconductor.

The above-mentioned substitution by the Ba element tends to lower the critical temperature. Further, in an environment with a smaller oxygen partial pressure, substitution by the Ba element tends to be suppressed, so the crystal is preferably grown not in the air but rather in a 0.1 to 1% oxygen atmosphere comprised of argon or nitrogen in which oxygen is mixed in a small amount. Further, by introducing silver into the superconducting bulk of an RE-Ba—Cu—O-based oxide superconducting bulk magnet, the mechanical strength and Jc characteristic tend to increase. Inclusion of silver in 5 to 20 mass % is more preferable. At this time, the 123 phase is sometimes off from a 1:2:3 stoichiochemical composition, and Ag is partially substituted at the Cu sites. However, this is deemed to be included in the 123 phase of the present invention.

The 123 phase can be formed by a peritectic reaction between the 211 phases and a liquid phase comprised of a composite oxide of Ba and Cu, that is, a reaction of

211 phases+liquid phase (composite oxide of Ba and Cu)→123 phase

Further, due to this peritectic reaction, the temperature at which the 123 phase can be formed (Tf: temperature of formation of 123 phase) becomes substantially related to the ion radius of the RE element. Along with the decrease of the ion radius, the Tf also becomes lower. Further, the Tf tends to fall along with a low oxygen atmosphere and addition of silver.

The superconducting bulk forming the oxide superconducting bulk magnet comprised of the single crystal form of 123 phase in which 211 phases are finely dispersed is formed due to the fact that when the 123 phase is grown as a crystal, unreacted 211 particles are left in the 123 phase. That is, the superconducting bulk forming an oxide superconducting bulk magnet can be formed by a reaction shown by

211 phases+liquid phase (composite oxide of Ba and Cu)→123 phase+211 phases

The fine dispersion of the 211 phases in the superconducting bulk of the oxide superconducting bulk magnet is extremely important from the viewpoint of improvement of the Jc. By adding a trace amount of at least one of Pt, Rh, or Ce, growth of particles of the 211 phases in the semi-molten state (state comprised of 211 phases and liquid phase) is suppressed and as a result the 211 phases in the material are refined to about 1 μm or less. The amounts of addition, from the viewpoint of the amounts at which a refining effect appears and of the material cost, are preferably Pt: 0.2 to 2.0 mass %, Rh: 0.01 to 0.5 mass %, and Ce: 0.5 to 2.0 mass %. The added Pt, Rh, and Ce are partially dissolved in the 123 phase. Further, the parts of the elements which were unable to dissolve in the 123 phase form composite oxides with Ba or Cu and remain scattered in the material.

Further, the oxide superconducting bulk magnet has to have a high critical current density (Jc) even in a magnetic field. To satisfy this condition, a single crystal form of 123 phase not containing high angle grain boundaries where the superconductive bonds become weak is effective. Furthermore, to obtain a high Jc characteristic, pinning centers for stopping movement of the magnetic flux are effective. What functions as such pinning centers are the finely dispersed 211 phases. Dispersion of a larger number more finely is preferable. Further, the 211 phases and other non-superconducting phases are finely dispersed in the easy-to-cleave 123 phase so as to mechanically strengthen the superconductor and play an important role in realizing a superconducting bulk magnet.

The ratio of the 211 phases in the 123 phase, from the viewpoint of the Jc characteristic and the mechanical strength, is preferably 5 to 35 vol %. Further, the superconducting bulk of the oxide superconducting bulk magnet generally contains 50 to 500 μm or so voids (bubbles) in 5 to 20 vol %. Furthermore, when adding silver, sometimes due to the amount of addition, silver particles or silver compounds having particle size 10 to 500 μm or so can be included in over 0 vol % to 25 vol %.

Further, when the amount of oxygen-deficiency “x” of the REBa₂Cu₃O₇₋ₓ phase contained in the superconducting bulk of the oxide superconducting bulk magnet after crystal growth is 0.5 or so, the electrical resistivity of the REBa₂Cu₃O₇₋ₓ phase shows a semiconductive change in temperature. By annealing this by different RE systems at 350° C. to 600° C. for 100 hours or so in an oxygen atmosphere, oxygen is taken into the material, the amount of oxygen deficiency “x” becomes 0.2 or less, and the REBa₂Cu₃O₇₋ₓ phase exhibits an excellent superconducting characteristic.

When fully magnetizing the ring-shaped oxide superconducting bulk magnet comprised of the above superconducting material, as shown in FIG. 4B, the maximum stress point is the side surface of the inner periphery of the ring. However, in the past, as shown in FIG. 2, only the high strength metal 22 of the outer periphery part was used for reinforcement, so the stress received at the columnar shaped oxide superconducting bulk magnet 21 from the outer periphery metal became weaker at the center part.

Therefore, it is effective to place at the center part a center core part provided with a reinforcing material arranged at outer periphery part thereof and to combine around the center core part one or more ring-shaped oxide superconducting bulk magnets provided with outer periphery parts reinforced by ring-shaped reinforcing materials in a nested manner. When combining ring-shaped oxide superconducting bulk magnets in a nested manner, the heat shrinkage rate when cooling the ring-shaped reinforcing materials reinforcing the outer periphery parts of the ring-shaped oxide superconducting bulk magnets and center core part from room temperature to 77K is preferably 0.16% or more.

The ordinary temperature tensile strength of the superconducting bulk is 60 MPa or so. Further, the ordinary tensile strength of solder for impregnation between the ring-shaped bulks described in PLT 8 is usually less than 80 MPa. In the present invention, it is preferable to use a reinforcing material having a 80 MPa or more ordinary temperature tensile strength so that the reinforcing material has a sufficiently strong ordinary temperature tensile strength with respect to solder.

Further, in the oxide superconducting bulk magnet according to the present invention, in light of the magnetic flux density required for the center part, the center part may be made of a center core member provided with an oxide superconductor and a ring-shaped reinforcing material reinforcing the outer periphery part of the oxide superconductor. Further, the center part may have a hollow structure with outer periphery part thereof reinforced by a ring-shaped reinforcing material.

When combining ring-shaped oxide superconducting bulk magnets in a nested manner, if current is run through the oxide superconducting bulk magnets, force acts on the oxide superconducting bulk magnets so as to broaden them in the radial direction. Further, the gap between the reinforcing material reinforcing the outer periphery part and the outside ring-shaped oxide superconducting bulk magnet may be filled with a resin, grease, or solder at least in part of the gap for the purpose of securing the clearance between adjacent oxide superconducting bulk magnets. In this case, filling 30% or less of the total volume of the gap with resin, grease, or solder is more preferable, while the filling rate of the gap less than 10% is more preferable. As part of the gap, a region of 30% or less of the entire periphery of the gap between the adjacent ring-shaped oxide superconducting bulk magnets or a region of an angle corresponding to 30% of the entire periphery (108°) or less may be filled with the resin. More preferably a region of less than 10% of the entire periphery of the gap between the adjacent ring-shaped oxide superconducting bulk magnets or a region of less than the angle corresponding to 10% of the entire periphery (36°) or less may be filled with the resin. If the filling rate exceeds 30%, interference between the stress applied to the outside ring-shaped superconducting bulk and the stress applied to the inside superconducting bulk becomes greater and fracturing easily occurs. As the resin, when semipermanently fastening the oxide superconducting bulk magnets after fabricating them, a curable resin is preferable. Further, to enable the nested oxide superconducting bulk magnets to be attached and detached, grease or solder is preferably used. Further, from the viewpoint of securing the clearance and avoiding contamination by foreign matter, only the top and bottom parts of the gap of the ring-shaped magnets are preferably filled with a resin, grease, or solder.

The space between a reinforcing material reinforcing an outer periphery part and a ring-shaped oxide superconducting bulk magnet in contact with the inside of the reinforcing material is preferably filled uniformly over the entire periphery with a resin, grease, or solder to evenly apply compression stress to the ring-shaped oxide superconducting bulk magnet. The reinforcing material is not particularly limited in material. Since a high strength can be easily obtained, it may also be a metal reinforcing material. For example, copper, aluminum, stainless steel, or another metal may be mentioned. During pulsed field magnetization, a large shield current flows in a good conductor, so an alloy material of stainless steel etc. with a high specific resistance is more preferable. Further, when semipermanently fastening the reinforcing material and the ring-shaped oxide superconducting bulk magnet which is in contact with the inside of the reinforcing material, a curable resin is preferably used for fastening them. Further, to enable the reinforcing material to be attached and detached, solder or grease may also be used for fastening them. When using solder, attachment and detachment become possible by heating them to its melting point, while when using grease, attachment and detachment become possible at ordinary temperature.

In particular, when using solder for fastening, the reinforcing material and oxide superconductor are fastened at the melting point of the used solder.

Therefore, when using high melting point solder, compared with when using low melting point solder, the compressive stress at the cooling temperature used in the superconducting state becomes larger. There are the advantages that it is possible to adjust the melting point of the solder to be used in this way to control the compressive stress at the time of cooling, and that it is possible to suitably adjust so as to obtain a balance with the Lorentz force at the time of magnetization, etc. The solder is comprised of an alloy of mainly Sn, Bi, Pb, Cd, In, Ag, Cu, etc. The melting point of a solder having a ratio of composition (mass ratio) of Bi (44.7), Sn (22.6), Sn (8.3), Cd (5.3), In (19.1) is relatively low, that is, 46.7° C. Further, in solder of a eutectic composition of Sn (96.5) and Ag (3.5), the melting point is relatively high, that is, 221° C. Further, a solder not containing Pb, Cd, or other highly toxic elements is more preferable. Furthermore, in the case of a solder, there are also the advantages of having a higher heat conductivity compared with resin or grease and the ease of maintaining a uniform temperature inside the oxide superconducting bulk magnets.

Next, when the ring-shaped oxide superconducting bulk magnet reinforced at outer periphery part thereof by a reinforcing material is comprised of a plurality of nested oxide superconducting bulk magnets, it is also possible to change the thickness of the reinforcing materials reinforcing the outer periphery parts in accordance with the position. In particular, the thickness of the reinforcing material reinforcing the outer periphery parts of the ring-shaped oxide superconducting bulk magnets is preferably made to be larger from the outside ring-shaped oxide superconducting bulk magnet to the inside ring-shaped oxide superconducting bulk magnet where a larger magnetic field stress occurs.

The nested RE-Ba—Cu—O-based oxide superconducting bulk magnets may be a combination of superconducting bulks with the same component elements of RE or may be a combination of a plurality of types of RE-Ba—Cu—O-based oxide superconducting bulk magnets differing in component elements of RE which are arranged in a nested manner. By changing the composition of the RE on the basis of the Jc characteristic of the RE-Ba—Cu—O-based oxide superconducting bulk magnets, it is possible to design the RE-Ba—Cu—O-based oxide superconducting bulk magnets so as to improve the overall characteristics of the oxide superconducting bulk magnets.

For the shapes of the nested oxide superconducting bulk magnets, up to here, the example of the structure where ring-shaped oxide superconducting bulk magnets having circular outer shapes are arranged concentrically was shown, but various shapes can be applied for similar reasons as the above. Suitable shapes may be selected so as to obtain the desired magnetic field distribution in an oxide superconducting bulk magnet suited for each application. For example, as the ring-shaped oxide superconducting bulk magnets, ones having triangular, tetragonal, pentagonal, hexagonal, septagonal, octagonal, or other polygonal shapes or rectangular, circular, elliptical, or other shapes or ones having race track shapes or other cross-sectional shapes may be mentioned. In these cases, the outside diameters of the oxide superconducting bulk magnets correspond to the shortest outside diameters of the different shapes.

From the viewpoint of practical use, the oxide superconducting bulk magnet more preferably is comprised of ring-shaped oxide superconducting bulk magnets having hexagonal or greater polygonal to circular shapes or ring-shaped oxide superconducting bulk magnets provided with top surfaces and bottom surfaces having race track shapes arranged in a nested manner. If the oxide superconducting bulk magnet has the above-mentioned shape, manufacture (working and assembly) of the oxide superconducting bulk magnet becomes easier and a more uniform magnetic field can be obtained by a stronger magnetic field. As such a polygonal shape, in light of the ease of working and assembly and the balance of the obtained performance of the magnetic field, a hexagonal or octagonal shape is more preferable.

In the present invention, the ring-shaped oxide superconducting bulk magnets, as explained above, are RE-Ba—Cu—O-based oxide superconducting bulk magnets, that is, oxide superconducting bulk magnets comprised of a REBa₂Cu₃O₇₋ₓ phase in which RE₂BaCuO₅ phases are dispersed. However, a relatively large superconducting current is run through the a-b face of the REBa₂Cu₃O₇₋ₓ phase in the oxide superconducting bulk magnets, so it is preferable to magnetize the ring-shaped oxide superconducting bulk magnets which are arranged so that the magnetic flux runs perpendicular to the a-b face is preferable. For this reason, the axis of rotational symmetry of the ring-shaped oxide superconducting bulk magnets preferably matches the c-axis of the REBa₂Cu₃O₇₋ₓ crystal.

Further, when the a-axes of the REBa₂Cu₃O₇₋ₓ crystal of the oxide superconducting bulk magnets adjacent perpendicularly to the axis of rotational symmetry of the ring-shaped oxide superconducting bulk magnet (layer direction of nesting) are respectively arranged in a nested manner offset, it is possible to obtain a more uniform magnetic field. Therefore, this arrangement is more preferable.

The oxide superconducting bulk magnet of the present invention exhibits magnetic characteristics excellent in magnetization performance able to generate a desired magnetic field distribution, so an oxide superconducting magnet system using the oxide superconducting bulk magnet of the present invention is a system which can easily generate a high magnetic field as a system as a whole by a lower amount of energy input. It is possible to obtain a system excellent in economy and environmental friendliness.

### EXAMPLES

### Example 1

Purity 99.9% reagents RE₂O₃ (RE: Gd), BaO₂, and CuO were mixed to give a molar ratio of the metal elements of Gd:Ba:Cu of 10:14:20 (that is, a molar ratio of the 123 phase:211 phase of the final structure of 3:1). Furthermore, Pt was added in 0.5 mass % and Ag₂O was added in 15 mass % to prepare mixed powders. The mixed powders were calcined once at 900° C. for 8 hours. The calcined powders were filled in inside diameter 72 mm cylindrical molds and then disk shapes having thickness about 33 mm were formed. Further, using Sm₂O₃ and Yb₂O₃, a method similar to the preparation of the above shaped articles was used to prepare Sm-based and Yb-based disk type shaped articles having thickness of 4 mm. Furthermore, each of the shaped articles was compressed by an isostatic pressing at about 100 MPa.

These were stacked on an alumina support member in the order of the Sm-based, Yb-based, and Gd—Dy-based shaped articles (precursors) from the bottom and placed in a furnace. These precursors were raised in temperature in the atmosphere to 700° C. in 15 hours, to 1040° C. in 160 hours, and furthermore to 1170° C., in 1 hour and held there for 30 minutes, then lowered in temperature down to 1030° C. in 1 hour and held there for 1 hour. During that time, using an Sm-based seed crystal prepared in advance, the seed crystal was placed on the precursors in the semimolten state. The cleavage surface of the seed crystal was placed on the precursors so that the c-axis of the seed crystal became normal to the disk shaped precursors. After that, this was cooled in the air down to 1000 to 985° C. over 250 hours and the crystal grown. Furthermore, this was cooled down to room temperature over about 35 hours to obtain an outside diameter about 54 mm, thickness about 24 mm Gd-based oxide superconducting material. Further, a similar method of the preparation of the Gd-based oxide superconducting material was used to further prepare two similar Gd-based oxide superconductor materials to prepare a total three (for the later explained sample A, sample B, and sample C) samples. These materials had the structure of a REBa₂Cu₃O₇₋ₓ phase in which 1 μm or so RE₂BaCuO₅ phases and silver particles having 50 to 500 μm particle size were dispersed.

Further, these three samples were processed after oxygen annealing to form the sample A of the superconducting bulk into the size of an outside diameter 50.0 mm, inside diameter 27.1 mm and thickness 15.0 mm. Further, the sample B of the superconducting bulk was formed to a column of an outside diameter of 25.0 mm and thickness 15.0 mm. The sample C of the superconducting bulk was prepared as a comparative material having the size of an outside diameter 50.0 mm and thickness 15.0 mm.

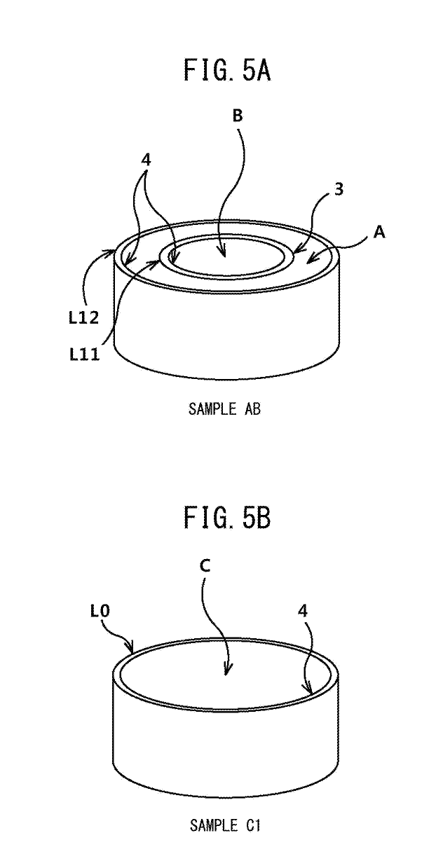

After that, at the outer periphery part of the sample B, the SUS316L ring L11 having an outside diameter 27.0 mm, inside diameter 25.1 mm and thickness 0.95 mm was arranged. The SUS316L ring L11 and the sample B were bonded by an epoxy resin 4 over the entire periphery. Further, at the outer periphery part of the sample A, the SUS316L ring L12 having an outside diameter 51.6 mm, inside diameter 50.1 mm and thickness 0.75 mm was arranged and similarly bonded by an epoxy resin 4 over the entire periphery. Further, in the sample A reinforced at the outer periphery part by a metal ring, the sample B was arranged. One-eighth of the gap between the sample A and the outer periphery reinforcing metal material of the sample B, or an equivalent in a center angle of 45°, was filled by grease 3 to join them. This joined sample was designated as the sample AB. Further, at the outer periphery part of the sample C, the SUS316L ring L0 having an outside diameter 51.6 mm and thickness 0.75 mm was arranged and similarly was bonded by an epoxy resin 4 over the entire periphery. FIGS. 5A and 5B show the structures of the invention example of the sample AB and the comparative example of the sample C1.

These sample AB and sample C were measured for trapped magnetic flux density of the surfaces by attaching five Hall elements at 10 mm intervals in lines passing through the centers of the surfaces of the samples. At this time, each third Hall element was attached to become the center of the corresponding sample. First, for magnetization at 70K, the samples were placed in a 6.0 T magnetic field at room temperature and cooled by a freezer to 70K, then the external magnetic field was reduced to zero at a 0.2 T/min demagnetization rate. At this time, the sample AB exhibited the maximum value of 3.95 T at the third Hall element. Further, the sample C similarly exhibited a value of 3.98 T. Next, the samples were magnetized at 60K. They were placed in a 10.0 T magnetic field at room temperature and cooled by a freezer to 60K, then the external magnetic field was reduced to zero by a 0.2 T/min demagnetization rate. At this time, the sample AB exhibited the maximum value of 6.90 T at the third Hall element. Further, the sample C exhibited a value of 6.95 T. Next, similarly, the samples were subjected to a 14 T magnetic field at room temperature and cooled to 50K, then the external magnetic field was reduced to zero. At this time, the sample AB exhibited 10.22 T that was a maximum value of the trapped magnetic flux density at the third Hall element. Further, the sample C exhibited the value of 1.35 T at the first Hall element, 2.75 T at the second Hall element, 0.35 T at the third Hall element, 3.02 T at the fourth Hall element, and 1.35 T at the fifth Hall element. At the center part, the trapped magnetic flux density fell. After the experiment, the sample C was taken out from the freezer and its surface was checked, whereupon a strong linear fracture passing through the vicinity of the center was confirmed.

From these comparative examples, it became clear that a superconducting bulk magnet comprised of superconducting bulk magnets reinforced by ring-shaped reinforcing materials and arranged in a nested manner (the invention example of the sample AB) could trap (generate) an over 10 T high magnetic flux density without fracturing as compared with a superconducting bulk magnet reinforced only at the outer periphery part by a metal ring (comparative example of the sample C).

### Example 2

Purity 99.9% reagents RE₂O₃ (RE: Dy), BaO₂, and CuO were mixed to give a molar ratio of the metal elements of Dy:Ba:Cu of 4:5:7 (that is, a molar ratio of the 123 phase:211 phase of the final structure of 2:1). Furthermore, CeBaO₃ was added in 1.0 mass % and Ag₂O was added in 10 mass % to prepare mixed powders. The mixed powders were calcined once at 900° C. for 8 hours. The calcined powders were filled in the cylindrical molds of inside diameter 100 mm to be formed into disk shapes of thickness about 40 mm. Further, using Sm₂O₃ and Yb₂O₃, a method similar to the preparation of the above shaped article was used to prepare Sm-based and Yb-based disk type shaped articles of thickness 4 mm. Furthermore, the shaped articles were compressed by an isostatic hydraulic press at about 100 MPa.

These were stacked on an alumina support member in the order of the Sm-based, Yb-based, and Dy-based shaped articles (precursors) from the bottom and placed in a furnace. These precursors were raised in temperature in the atmosphere to 700° C. in 15 hours, to 1040° C. in 160 hours, and furthermore to 1170° C. in 1 hour and held there for 30 minutes, then lowered in temperature down to 1030° C. in 1 hour and held there for 1 hour. During that time, using an Sm-based seed crystal prepared in advance, the seed crystal was placed on the precursors in the semimolten state. The sheared surface of the seed crystal was placed on the precursors so that the c-axis of the seed crystal was oriented to the normal direction of the disk shaped precursors. After that, this was cooled in the air down to 990 to 970° C. over 250 hours and the crystal grown. Furthermore, this was cooled down to room temperature over about 35 hours to obtain a Dy-based oxide superconducting material having an outside diameter about 75 mm, thickness about 30 mm. Further, a similar method of the preparation of the Dy-based oxide superconducting material was used to further prepare two similar Dy-based oxide superconductor materials and prepare a total three samples (for the later mentioned sample D, sample E, and sample F). These materials had structures comprised of a REBa₂Cu₃O₇₋ₓ phase in which RE₂BaCuO₅ phases having sizes of 1 μm or so and silver particles having sizes of 50 to 500 μm were dispersed.

Further, these three samples were processed after oxygen annealing to cut out from the sample D a ring-shaped superconducting bulk having an outside diameter 71.9 mm, inside diameter 51.1 mm and thickness 25.0 mm as the sample (D1) and a diameter 25.9 mm, thickness 25.0 columnar superconducting bulk as the sample (D2). Further, the sample E of the superconducting bulk was processed to cut out a ring shape having an outside diameter 47.9 mm, inside diameter 30.1 mm and thickness 25.0 mm. The sample F was formed, as a comparative material, into a column having an outside diameter 71.9 mm and thickness 25.0 mm.

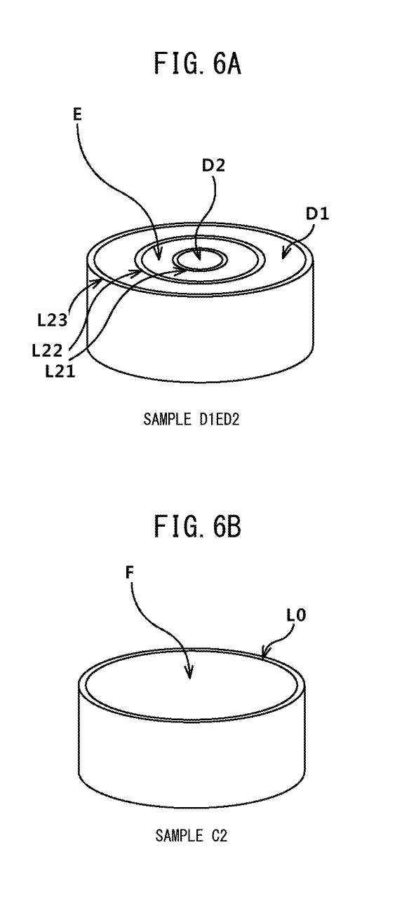

Next, at the outer periphery part of the sample D1, the SUS316L ring L23 having an outside diameter 74.0 mm, inside diameter 71.9 mm and thickness about 1.0 mm was arranged. In the same way as Example 1, an epoxy resin 4 was used to bond the ring L23 over its entire periphery. Further, at the outer periphery part of the sample E, the SUS316L ring L22 having an outside diameter 51.0 mm, inside diameter 48.1 mm and thickness about 1.5 mm was arranged. The SUS316L ring L22 and the sample E were bonded by an epoxy resin 4 over the entire periphery. Further, at the outer periphery part of the sample D2, the SUS316L ring L21 having an outside diameter 30.0, inside diameter 26.1 mm and thickness about 2.0 mm was arranged. In the same way, an epoxy resin 4 was used to bond the ring L21 over the entire periphery. Further, in the sample D1 reinforced at the outer periphery part by a metal ring, the sample E was arranged. Furthermore, in the sample E, the sample D2 was arranged. At the gap part of the sample D1 and the sample E and the gap part of the sample E and the sample D2, grease was filled in an equivalent in a 15° center angle to join them. The filling rate of the grease in the gap parts was about 4.17%. The joined sample was designated as the sample D1ED2. Further, at the outer periphery part of the sample F, the SUS316L ring L0 having an outside diameter 74.0 mm and thickness 1.0 mm was arranged and similarly was bonded by an epoxy resin 4 over the entire periphery. FIGS. 6A and 6B show the structures of the invention example of the sample D1ED2 and the comparative example of the sample C2, respectively.

These sample D1ED2 and sample F were measured for trapped magnetic flux density of the surfaces by attaching five Hall elements at 10 mm intervals in lines passing through the centers of the surfaces of the samples. At this time, each third Hall element was attached to become the center of the corresponding sample. First, for magnetization at 75K, the samples were placed in a 8.0 T magnetic field at room temperature and cooled by a freezer to 75K, then the external magnetic field was reduced to zero at a 0.2 T/min demagnetization rate. At this time, the sample D1ED2 exhibited the maximum value of 4.4 T at the third Hall element. Further, the sample F similarly exhibited a value of 4.9 T. Next, the samples were magnetized at 65K. They were placed in a 12.0 T magnetic field at room temperature and cooled by a freezer to 65K, then the external magnetic field was reduced to zero at a 0.2 T/min demagnetization rate. At this time, the sample D1ED2 exhibited the maximum value of 7.1 T at the third Hall element. Further, the sample F exhibited a value of 2.0 T at the first Hall element, 4.1 T at the second Hall element, 0.15 T at the third Hall element, 4.12 T at the fourth Hall element, and 1.05 T at the fifth Hall element. At the center part, the trapped magnetic flux density fell. After the experiment, the sample F was taken out from the freezer and its surface was checked, whereupon a strong linear fracture passing through the vicinity of the center was confirmed.

From the comparative examples, it is clear that a superconducting bulk magnet comprised of a plurality of nested superconducting bulk magnets reinforced by ring-shaped reinforcing materials (invention example of sample D1ED2) can trap (generate) a high magnetic flux density of over 10 T without fracturing as compared with a superconducting bulk magnet reinforced at only the outer periphery part by a metal ring (comparative example of sample F).

### Example 3

Purity 99.9% reagents RE₂O₃ (RE composition: Dy:Gd=1:1), BaO₂, and CuO were mixed to give a molar ratio of the metal elements of RE:Ba:Cu of 4:5:7 (that is, a molar ratio of the 123 phase:211 phase of the final structure of 2:1). Furthermore, CeO₂ was added in 0.5 mass % and Ag₂O was added in 10 mass % to prepare mixed powders. The mixed powders were calcined once at 900° C. for 8 hours. The calcined powders were filled in inside diameter 100 mm cylindrical molds and then disk shapes having thickness about 40 mm were formed. Further, using Sm₂O₃ and Yb₂O₃, a method similar to the preparation of the above shaped article was used to prepare Sm-based and Yb-based disk type shaped articles having thickness 4 mm. Furthermore, each of the shaped articles was compressed by an isostatic hydraulic press at about 100 MPa.

These were stacked on an alumina support member in the order of the Sm-based, Yb-based, and Dy—Gd-based shaped articles (precursors) from the bottom and placed in a furnace. These precursors were raised in temperature in the atmosphere to 700° C. in 15 hours, to 1040° C. in 60 hours, and furthermore to 1170° C., in 1 hour and held there for 30 minutes, then lowered in temperature down to 1030° C. in 1 hour and held there for 1 hour. During that time, using an Sm-based seed crystal prepared in advance, the cleavage surface of the seed crystal was placed on the precursors in the semimolten state. The seed crystal was placed on the precursors so that the c-axis of the seed crystal became normal to the disk shaped precursors. The sheared surface was placed on the precursors. After that, this was cooled in the air down to 995 to 975° C. over 250 hours and the crystal grown. Furthermore, this was cooled down to room temperature over about 35 hours to obtain the Dy—Gd-based oxide superconducting material having an outside diameter about 75 mm and thickness about 30 mm. Further a similar method of the preparation of the Dy—Gd-based oxide superconducting material was used to further prepare five similar Dy—Gd-based oxide superconductor materials to thereby prepare a total of six samples. These materials had structures comprised of a REBa₂Cu₃O₇₋ₓ phase in which 1 μm or so RE₂BaCuO₅ phases and 50 to 500 μm silver particles are dispersed.

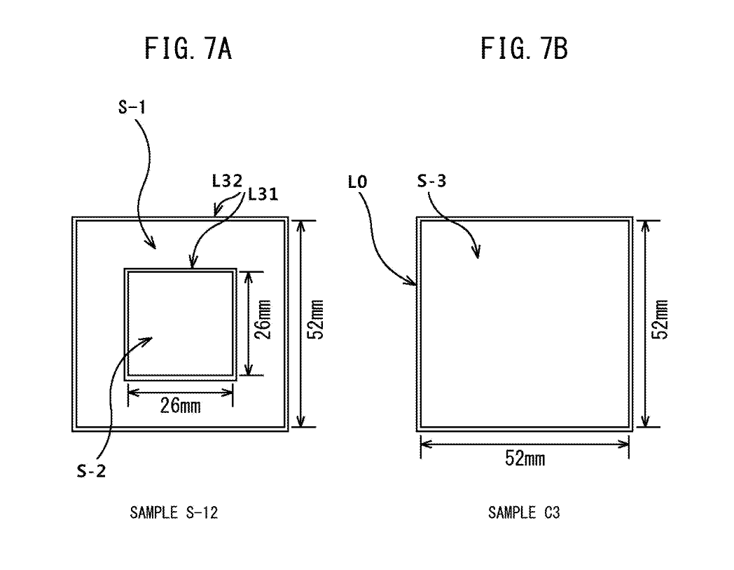

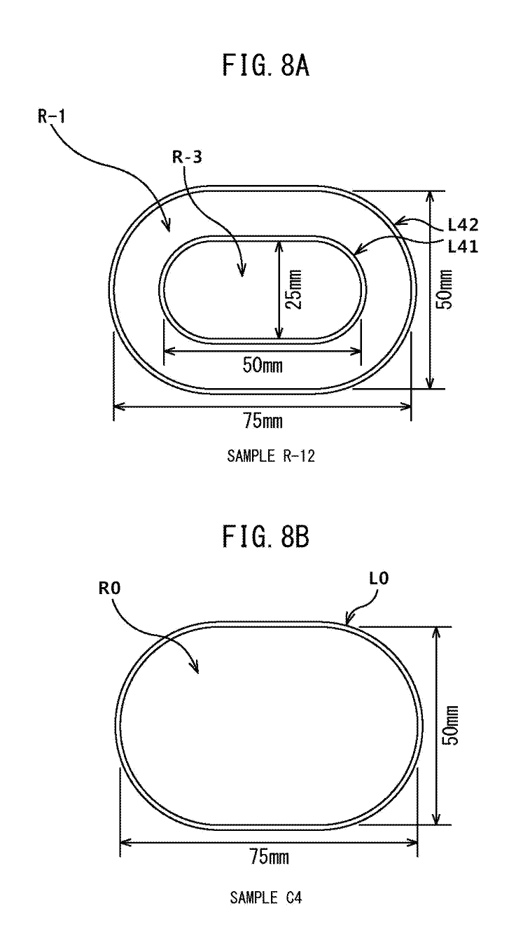

Further, these six samples were processed after oxygen annealing to be formed into three square shaped samples of thickness 30 mm shown in FIGS. 7A and 7B and three race track shaped samples shown in FIGS. 8A and 8B. The sample S-1 of the square type ring-shaped superconducting bulk shown in FIG. 7A is provided at the inside with a space a little bit larger than the sample S-2 of the square type ring-shaped superconducting bulk. As shown in FIG. 7A, thickness 1.0 mm SUS316L rings L32 and L31 were fit over the outer periphery parts of the superconducting bulks of the sample S-1 and the sample S-2 and bonded by resin over the entire periphery. Next, the sample S-2 was placed in the center space of the sample S-1 and grease was filled in a region corresponding to about 15% of the gap between the outer periphery reinforcing material L31 of the sample S-2 and the sample S-1 to join them and prepare the sample S-12. Further, as shown in FIG. 7B, a thickness 1.0 mm SUS316L ring L0 was fit over the outer periphery part of the superconducting bulk of the comparative material of the sample S-3 by bonding over the entire periphery by a resin to prepare a comparative example of the sample C3. When producing the sample S-3 and the sample 3, the corner parts of the square shaped samples and reinforcing materials were chamfered.

Further, the sample R-1 shown in FIG. 8A is provided at inside thereof with a space a little bit larger than the sample R-2. As shown in FIG. 8A, the SUS316L rings L42 and L41 of thickness 1.0 mm were fit over the outer periphery parts of the superconducting bulks of the sample R-1 and the sample R-2 while bonding the entire peripheries by a resin in the same way as Example 1. Next, the sample R-2 was arranged in the center space of the sample R-1 and grease was filled in the gap between the outer periphery reinforcing material of the sample R-2 and the sample R-1 in a region corresponding to about 10% to join them and prepare the sample R-12. As shown in FIG. 8B, a thickness 1.0 mm SUS316L ring L0 was fit over the outer periphery part of the superconducting bulk of the comparative material of the sample R-3 while bonding the entire peripheries by a resin in the same way as Example 1 to prepare the comparative example of the sample C4.

A method similar to Examples 1 and 2 was used to test the invention example of the square shape type sample S-12 and its comparative example (sample C3) and the invention example of the race track type sample R-12 and its comparative example (sample C4) by a similar magnetization test, and the invention examples and the comparative examples were confirmed and tested for the magnetized magnetic field strength (applied magnetic field) at different temperatures, the trapped magnetic flux density at the center position at that time, and fracturing after measurement. The results are shown in the following Table 1.

TABLE 1

| Condition | | Sample | S-12 | C3 | R-12 | C4 |
|---|---|---|---|---|---|---|
| 1 | Temperature | 70 | 3.82 | 3.97 | 3.91 | 4.02 |
| | (K) | | | | | |
| | Applied | 6.0 | | | | |
| | magnetic | | | | | |
| | field (T) | | | | | |
| 2 | Temperature | 60 | 6.85 | 6.97 | 6.92 | 7.11 |
| | (K) | | | | | |
| | Applied | 10.0 | | | | |
| | magnetic | | | | | |
| | field (T) | | | | | |
| 3 | Temperature | 50 | 10.12 | 1.35 | 10.21 | 0.48 |
| | (K) | | | (fracturing | | (fracturing |
| | Applied | 14.0 | | confirmed) | | confirmed) |
| | magnetic | | | | | |
| | field (T) | | | | | |

The sample S-12 and the sample R-12 of the invention examples gave over 10 T high magnetic flux densities at 50K, while the comparative materials of the sample C3 and the sample C4 fractured and became low in magnetic flux density. The effect of the present invention could be confirmed.

### INDUSTRIAL APPLICABILITY

The present invention can provide an oxide superconducting bulk magnet able to generate a strong magnetic field which does not fracture at the time of magnetization in a 5 T or more high magnetic field even if a diameter 50 mm or more large size. Further, the oxide superconducting bulk magnet according to the present invention is resistant to fracture and cracking, so can provide an oxide superconducting bulk magnet which can be magnetized with excellent symmetry and uniformity.

### REFERENCE SIGNS LIST

1. ring-shaped oxide superconducting bulk magnet
2. reinforcing material
3. grease
4. epoxy resin
20. columnar superconducting bulk
H. magnetic field
H_{MAX}. maximum magnetic field
J. superconducting current
L12, L11. SUS316L rings
A, B. superconducting bulk samples
L23, L22, L21. SUS316L rings
D1, D2, E. superconducting bulk samples
L32, L31. SUS316L rings
S-1, S-2. superconducting bulk samples
L42, L41. SUS316L rings
R-1, R-2. superconducting bulk samples

1. An oxide superconducting bulk magnet comprised of a REBa₂Cu₃O₇₋ₓ phase in which the RE₂BaCuO₅ phases are dispersed,
said oxide superconducting bulk magnet comprising a ring-shaped oxide superconducting bulk magnet with a reinforcing material provided at outer periphery part thereof and
wherein at the inside of said ring-shaped oxide superconducting bulk magnet, one or more ring-shaped oxide superconducting bulk magnets with reinforcing materials provided at outer periphery parts thereof are arranged to be nested, where,
RE: a rare earth element or combination of the same;
x: amount of oxygen deficiency, 0<x≦0.2

2. The oxide superconducting bulk magnet according to claim 1,
wherein a center core part of a columnar shaped oxide superconducting bulk magnet provided with a reinforcing material at outer periphery part thereof is placed at the inside of said nested ring-shaped oxide superconducting bulk magnets.

3. The oxide superconducting bulk magnet according to claim 1,
wherein said oxide superconducting bulk magnet can be magnetized to generate 5 T or more magnetic flux and has an outside diameter of 50 mm or more.

4. The oxide superconducting bulk magnet according to claim 1,
wherein the reinforcing materials reinforcing the outer periphery parts of said nested ring-shaped oxide superconducting bulk magnets differ in thickness depending on the position.

5. The oxide superconducting bulk magnet according to claim 4,
wherein said reinforcing materials are made to be thicker from the outside to the inside of said oxide superconducting bulk magnets.

6. The oxide superconducting bulk magnet according to claim 1,
wherein the shape of said ring-shaped oxide superconducting bulk magnets is a shape having a polygonal shape or elliptical shape, or top surface and bottom surface of said ring-shaped oxide superconducting bulk magnets are race track shapes.

7. The oxide superconducting bulk magnet according to claim 2,
wherein said oxide superconducting bulk magnet can be magnetized to generate 5 T or more magnetic flux and has an outside diameter of 50 mm or more.

8. The oxide superconducting bulk magnet according to claim 2,
wherein the reinforcing materials reinforcing the outer periphery parts of said nested ring-shaped oxide superconducting bulk magnets differ in thickness depending on the position.

9. The oxide superconducting bulk magnet according to claim 3,
wherein the reinforcing materials reinforcing the outer periphery parts of said nested ring-shaped oxide superconducting bulk magnets differ in thickness depending on the position.

10. The oxide superconducting bulk magnet according to claim 2,
wherein the shape of said ring-shaped oxide superconducting bulk magnets is a shape having a polygonal shape or elliptical shape, or top surface and bottom surface of said ring-shaped oxide superconducting bulk magnets are race track shapes.

11. The oxide superconducting bulk magnet according to claim 3,
wherein the shape of said ring-shaped oxide superconducting bulk magnets is a shape having a polygonal shape or elliptical shape, or top surface and bottom surface of said ring-shaped oxide superconducting bulk magnets are race track shapes.

12. The oxide superconducting bulk magnet according to claim 4,
wherein the shape of said ring-shaped oxide superconducting bulk magnets is a shape having a polygonal shape or elliptical shape, or top surface and bottom surface of said ring-shaped oxide superconducting bulk magnets are race track shapes.

13. The oxide superconducting bulk magnet according to claim 5,
wherein the shape of said ring-shaped oxide superconducting bulk magnets is a shape having a polygonal shape or elliptical shape, or top surface and bottom surface of said ring-shaped oxide superconducting bulk magnets are race track shapes.
